(19) United States
(12) Patent Application Publication
(10) Pub. No.: US 2006/0032206 A1
(43) Pub. Date: Feb. 16, 2006

(54) Vibration transporter for harvesting fruit

(76) Inventor: John Hosking, Oakville (CA)

Correspondence Address: GOWLING, LAFLEUR HENDERSON LLP, ONE MAIN STREET WEST, HAMILTON, ON, L8P 4Z5, CA

(21) Appl. No.: 10/916,489

(22) Filed: Aug. 12, 2004

(51) Int. Cl. A01D 46/00

(52) U.S. Cl. 56/340.1

(57) ABSTRACT

A vibration transporter for harvesting fruit which includes an inclined platform that receives falling fruit at an upper end and delivers the fruit to a lower end. The platform vibrates to move the fruit from the upper end to the lower end and is coupled to an orbiting shaft eccentrically mounted to a driven shaft. The speed of rotation of the driven shaft is selected to be commensurate with the vertical displacement of the platform so that the fruit bounces toward the lower end of the platform during upward travel of the vibrating platform.

### FIELD OF INVENTION

This invention relates to a conveyor and in particular, apparatus for moving falling fruit to a collection device for transfer away from an orchard.

### BACKGROUND OF THE INVENTION

There is considerable interest in automating the collection of fruit in orchards, and in particular, orange groves, for transportation to a fruit processing plant for producing juice and juice blends. One apparatus which has been developed consists of a fruit tree shaker such as in U.S. Pat. No. 6,425,233 whereby fruit trees are shaken to loosen fruit so that they drop from the tree and careful manual picking of the fruit is avoided.

A problem which arises with tree shakers is that the fruit must still be collected from the bottom of the tree. Various catchment aprons and conveyors to harvest fruit or nuts have been developed such as described in U.S. Pat. No. 4,157,642; U.S. Pat. No. 3,553,949; U.S. Pat. No. 3,417,559; U.S. Pat. No. 3,218,790; and U.S. Pat. No. 2,692,470. The aforementioned prior art devices are complex, this adds to cost and also adversely affects reliability in the field.

An object of this invention is to provide a simple mechanical means for harvesting falling fruit to enable the automatic collection of fruit to take place.

### SUMMARY OF THE INVENTION

In accordance with this invention, there is provided a vibration transporter for harvesting fruit which includes an inclined platform for receiving falling fruit at an upper end and delivering the fruit to a lower end, the platform being adapted to vibrate so as to move fruit down the platform. The platform is coupled to an orbiting shaft which is rotatable in an orbital path and preferably, the orbiting shaft is eccentric to a driven shaft which, in use, is associated with a motor. The speed of rotation of the driven shaft is selected to be commensurate with the vertical displacement of the platform so that fruit is bounced toward the lower end during upward travel of the vibrating platform.

### BRIEF DESCRIPTION OF THE DRAWINGS

In order that the invention can better be understood, a preferred embodiment as described below with reference to the accompanying drawings, in which:

FIG. 1 is a perspective view of a vibration transporter in accordance with the invention, a platform being shown in ghost outline;

FIG. 2a is a front elevation view of the vibration transporter showing the platform in its lowermost position;

FIG. 2b is a front elevation view of the vibration transporter showing the platform in its uppermost position; and

FIGS. 3a to 3e are schematic side elevational views showing the vibration transporter receiving a fallen orange at different stages throughout a single orbit cycle.

### DESCRIPTION OF PREFERRED EMBODIMENT WITH REFERENCE TO THE DRAWINGS

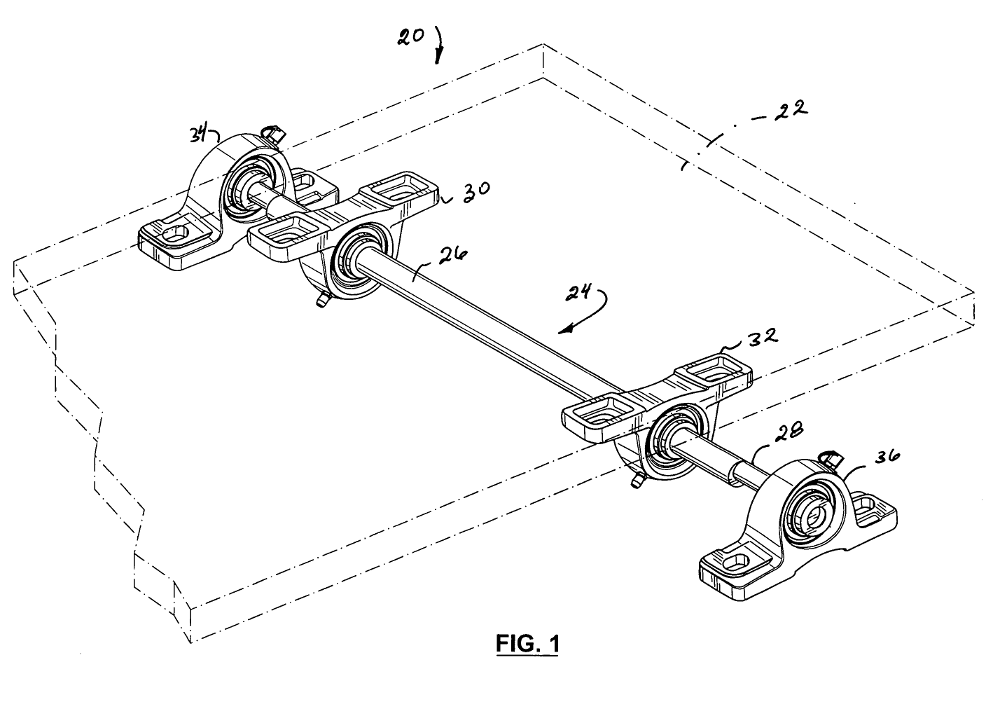

A vibration transporter for harvesting fruit made in accordance with the invention is generally indicated in the drawings by reference numeral 20. In the embodiment illustrated, the transporter 20 has an inclined platform 22 which may be sized in accordance with the requirements of the orchard in which the fruit is being harvested. In a preferred embodiment, the platform has a length of about 15 feet and a width of about 7 feet. The platform itself may be constructed from wood or other suitable material with a thickness of about ½ inch. The platform 22 is supported in an inclined position so as to have a angle relative to the ground of 3° to 4° and an upper end of the platform 22 is drawn the right of FIG. 1 where it is supported by a vibration mechanism 24. The vibration mechanism 24 extends across the width of the platform 22 and is spaced from the free upper end of the platform so that the end of the platform is cantilevered. A free lower end of the platform (not shown) rests on a conveyor.

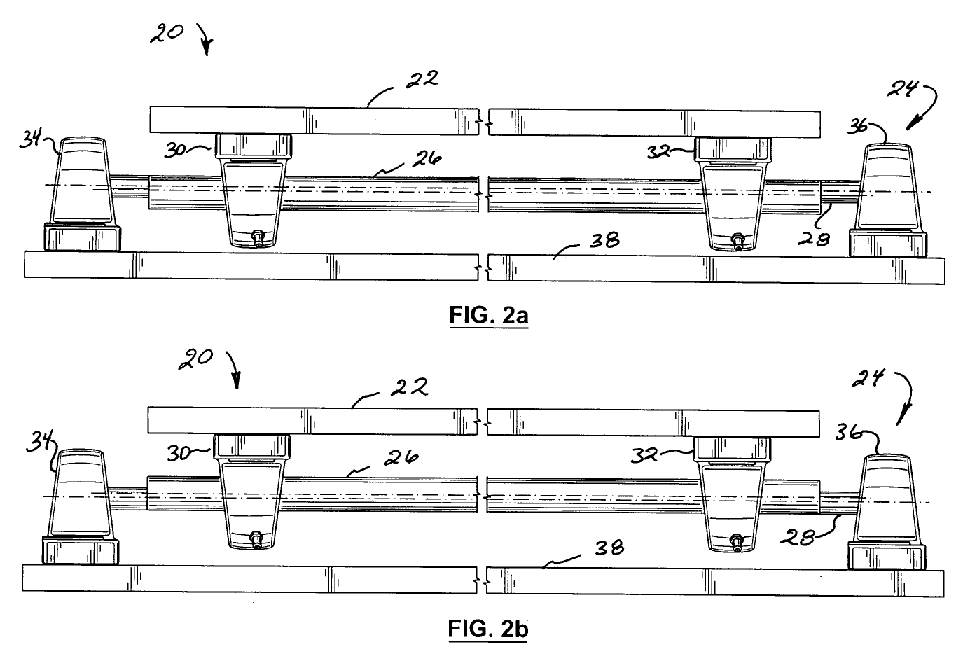

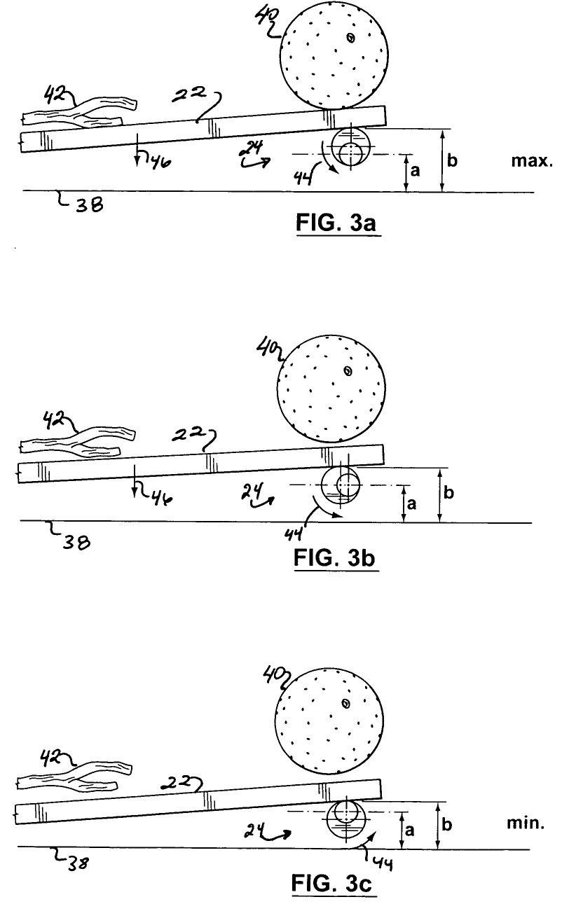

The vibration mechanism consists of a transversely extending orbiting shaft 26 which is eccentrically mounted to a driven shaft 28 driven by an electric or hydraulic motor (not shown). The orbiting shaft 26 is received in a pair of transversely spaced bearing housings 30, 32 each having a pair of lugs oriented for attachment to a bottom surface of the platform 22, as can be seen more clearly in FIGS. 2a, 2b. An additional pair of bearing housings 34, 36 receive terminal ends of the driven shaft 28 which extend on opposite sides from the orbiting shaft 26 beyond the width of the platform 22. The bearing housings 34, 36 are oriented to be secured by respective lugs to a base 38 (FIGS. 2a, 2b). The base 38 must be made with sufficient mass to hold down the vibration transporter as otherwise it may be lifted off the ground during rotation of the orbiting shaft 26.

In use, the vibration transporter 20 made in accordance with the invention would be provided in pairs disposed on opposite sides of a tree and the tree would have a collection plate or skirt coupled to the trunk of the tree to direct fruit to the platforms 22 on opposite sides.

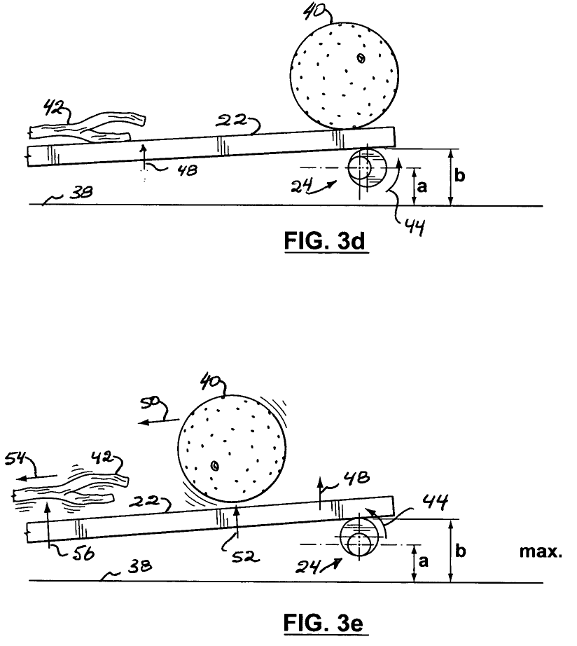

The operation of the vibration transporter 20 will now be described with reference being made in particular to FIGS. 2a, 2b and 3a to 3e. The platforms 22, in turn, would direct the fruit to a conveyor.

Two extreme positions of the driven shaft 28 are shown in FIGS. 2a and 2b where the orbiting shaft 26 is shown in its lowermost position in FIG. 2a and in its uppermost position in FIG. 2b. The figures thus show half of an orbit cycle in which the platform 22 is being pushed upward by the orbiting shaft 26. As the driven shaft 28 continues to rotate in its orbit cycle, the platform 22 will be pulled down from the uppermost position shown in FIG. 2b to return it to the lowermost position shown in FIG. 2a.

A complete orbit cycle is shown in FIGS. 3a to 3e in which the platform 22 is shown in a position where it has a maximum height “b” above the base 38 in FIG. 3a and 3e while it is shown with a minimum height “b” in FIG. 3c and at intermediate heights “b” in FIGS. 3b and 3d. In the drawings, the height “a” is constant and indicates the separation between the centre of rotation of the driven shaft 28 from the base 38.

A full orbit cycle will now be described. It will be seen that an exemplary piece of fruit, in this case an orange 40 is at rest on the platform 22 where it has fallen. Since the fruit is usually of a generally spherical shape, it will have a tendency to roll from the upper end of the platform 22 toward the lower end of the platform to the left of FIGS. 3a to 3e. It is important that the incline of the platform have a minimum slope to ensure descent of the fruit 40. Since the fruit will have been disengaged from the fruit tree by shaking the tree, it is inevitable that other debris from the tree will also fall on the platform 22. An exemplary twig 42 is shown in the drawings and is drawn to the left of the platform 22. It will be understood that the debris such as the twig 42 will in effect act as an obstacle to the fruit 40 rolling from the upper end of the platform to the lower end of the platform for collection by a conveyor (not shown). By causing the platform to vibrate, the debris including the twig 42 is made to scatter and also the fruit 40 is caused to bounce along the platform so that it can get past any obstacles in its way.

As the vibration mechanism 24 rotates as indicated by arrow 44, the platform 22 is displaced downwardly as indicated by arrow 46. The driven shaft 28 has a speed of rotation which is fast enough to pull the platform 22 downwardly as indicated by arrow 46 so that the fruit remains airborne as shown in FIGS. 3b and 3c.

In the embodiment illustrated, the platform 22 has reached its minimum height “b” in FIG. 3c after which it begins to rise again as indicated by arrow 48 in FIG. 3d where the driven shaft 28 has traveled ¾ of an orbit cycle. At this point, the platform 22 meets the falling fruit 40 thereby causing it to bounce forwardly and upwardly as indicated by arrows 50, 52 drawn in FIG. 3e. Likewise, the twig 42 bounces forwardly and upwardly as indicated by arrows 54, 56.

Reexamining FIGS. 3a and 3d, it will be seen that the net vertical displacement of the platform 22 is equal to the orbital radius of the vibration mechanism 24, that is, the separation between the centre of rotation for the driven shaft 28 and the centre of the orbiting shaft 26. In a preferred embodiment of the invention, the orbital radius is selected to be 3/16 inch. In FIG. 3d, the driven shaft 28 has traveled ¾ of an orbit cycle and therefore the driven shaft 28 must rotate fast enough at a frequency which will bring it from the position shown in FIG. 3a to the position shown in FIG. 3d (¾ of a cycle) in the time it takes the fruit to fall a height which in this case equals the orbit radius. In a preferred embodiment of the invention, the rotation frequency of the driven shaft 28 is 1200 revolutions per minute.

While fruit will be falling from the tree and reaching the platform at different times during the orbit cycle, maintaining a relationship between the rotation frequency and the orbit radius is critical to ensure that the fruit is disturbed enough to migrate down the platform 22. If the rotation frequency is too slow, fruit will tend to be bounced backwards towards the trunk whereas if the rotation is too fast there is relatively little forward impact on the fruit and unnecessary energy is used to perform the harvesting. The invention provides for the fallen fruit to be bounced toward the lower end of the platform 22 during the last quarter of an orbit cycle during the upward travel of the platform 22. This gives the fruit sufficient impact and forward force to cause it to travel as desired and as illustrated in FIG. 3e.

It will of course be understood that several variations may be made to the above described embodiment of the invention within the scope of the appended claims, as will be appreciated by those skilled in the art. It will also be understood that the vibration transporter made in accordance with the invention is not limited to the harvesting of oranges although this is an application where the invention has particular utility since bruising of the fruit for the production of juice is not a major concern.

1. A vibration transporter for harvesting fruit, the transporter having an inclined platform for receiving falling fruit at an upper end and delivering fruit to a lower end, the platform being coupled to a vibrator for moving fallen fruit from said upper end to said lower end.

2. A vibration transporter according to claim 1 in which the vibrator consists of an orbiting shaft eccentrically mounted to a driven shaft for rotation in an orbital path, the separation between the centre of rotation for the driven shaft and the centre of the orbiting shaft defining an orbit radius.

3. A vibration transporter according to claim 2 having a motor for driving the driven shaft.

4. A vibration transporter according to claim 2 in which the driven shaft has a speed of rotation which is commensurate with the orbit radius so that fallen fruit is bounced toward said lower end during upward travel of the platform.

5. A vibration transporter according to claim 4 in which the driven shaft has a selected speed of rotation commensurate with moving the platform through a net vertical displacement which equals the orbit radius when the driven shaft has traveled ¾ of an orbit cycle.

6. A vibration transporter according to claim 1 in which the platform is inclined by angle of 3° to 4° to the horizontal.

7. A vibration transporter for harvesting fruit, the transporter having an inclined platform for receiving falling fruit at an upper end and delivering fruit to a lower end, the platform being coupled to a vibrator for moving fallen fruit from said upper end to said lower end, the vibrator consisting of an orbiting shaft eccentrically mounted to a driven shaft for rotation in an orbital path, the separation between the center of rotation for the driven shaft and the center of the orbiting shaft defining an orbit radius, and the driven shaft having a speed of rotation which is commensurate with the orbit radius so that fallen fruit is bounced toward said lower end during upward travel of the platform.

8. A vibration transporter according to claim 7 in which the driven shaft has a selected speed of rotation commensurate with moving the platform through a net vertical displacement which equals the orbit radius when the driven shaft has traveled ¾ of an orbit cycle.
